(19) United States
(12) Patent Application Publication
(10) Pub. No.: US 2009/0327107 A1
(43) Pub. Date: Dec. 31, 2009

(54) CONSUMER SPENDING THRESHOLD EVALUATION

(76) Inventors: Raghav Lal, Palo Alto, CA (US); Mukund M. Sheorey, Upper Saddle River, NJ (US); Irfan Y. Tareen, Redwood City, CA (US)

Correspondence Address: TOWNSEND AND TOWNSEND CREW LLP, TWO EMBARCADERO CENTER, 8TH FLOOR, SAN FRANCISCO, CA, 94111, US

(21) Appl. No.: 12/483,106

(22) Filed: Jun. 11, 2009

Related U.S. Application Data
(60) Provisional application No. 61/076,860, filed on Jun. 30, 2008.

(51) Int. Cl. G06Q 20/00; G06Q 10/00; G06Q 40/00; G06F 15/16

(52) U.S. Cl. 705/30; 705/35; 709/204

(57) ABSTRACT

A method comprising receiving, by a server computer, an authorization request for a transaction conducted with a payment token from a merchant via an open payment processing network. The payment token associated with an account having a no preset spending limit. The method also determines, by the server computer, an exposure limit of the account in real-time based on information obtained by the open payment processing network. The method also determines, by the server computer, whether or not to authorize the transaction based on the determined exposure limit.

### CROSS-REFERENCES TO RELATED APPLICATIONS

The present application claims the benefit of priority under 35 U.S.C. §119 from U.S. Provisional Patent Application Ser. No. 61/076,860, entitled “Consumer Spending Threshold Evaluation,” filed on Jun. 30, 2008, the disclosure of which is hereby incorporated by reference in its entirety for all purposes.

### BACKGROUND

For small businesses, high dollar items such as rent and raw materials account for more than 40% of total spending. To pay for high dollar items, small businesses typically use more traditional payment methods such as checks. Small businesses can have irregular revenue cycles and often need a line of credit available on a business credit card or other payment token.

Many conventional business credit cards do not permit transactions beyond pre-defined spending limits. New consumers are usually assigned a low initial credit limit. The credit limit is slowly increased over time as the consumer's tenure increases. The need for higher credit at the start up of a business is usually not a key factor in determining the initial credit limit. Consequently, conventional business credit cards may not have the spend bandwidth required to allow new businesses to purchase high dollar items often needed at or around start up. In some cases, transactions may be declined at the point of sale (POS), without notification or direct contact with the consumer.

Some conventional systems offer credit cards with no preset spending limit for business consumers (e.g., a no pre-set spending limit card offered by American Express). While such systems are useful, they generally use a “closed network” which is not generally open for use by many pre-existing independently operated banks. For example, Amex offers a no preset spending limit card for its business consumers. Amex functions as both an acquirer (e.g., a bank that does business with merchants who accept credit cards) and an issuer (e.g., a bank that extends credit to customers through bankcard accounts), and uses a closed network to conduct its financial transactions. Because the closed network receives a limited amount of transaction data, and cannot perform an optimal risk analysis, the issuer/acquirer that uses the closed network bears a substantial risk when allowing a business consumer to use a card with a no preset spending limit.

It would be desirable to provide business and other types of consumers with credit cards or other payment tokens with no preset spending limits, while also reducing the exposure to the entity that provides credit to the consumers.

Embodiments of the present disclosure address these and other problems, individually and collectively.

### BRIEF SUMMARY

Embodiments of the invention are directed to methods and systems that process transactions conducted with payment tokens associated with no preset spending limits.

One embodiment of the invention is directed to a method comprising receiving an authorization request for a transaction conducted with a payment token from a merchant via an open payment processing network. The payment token is associated with a no preset spending limit. The method also includes determining an exposure limit in real-time based on information obtained by the open payment processing network, and determining whether or not to authorize the transaction based on the determined exposure limit.

Another embodiment of the invention is directed to a transaction authorization system configured to receive an authorization request for a transaction conducted with a payment token from a merchant via an open payment processing network. The payment token is associated with a no preset spending limit. The transaction authorization system is also configured to determine an exposure limit in real-time based on information obtained by the open payment processing network, and determine whether or not to authorize the transaction based on the determined exposure limit.

These and other embodiments of the invention are described in detail below, and are further described in the document in the attached Appendix which is incorporated herein by reference in its entirety.

### BRIEF DESCRIPTION OF THE FIGURES

FIG. 1 is a block diagram of a system, in accordance with an embodiment of the invention.

FIG. 2 is a block diagram of the decision making process through the no preset spending limit account management system, in accordance with an embodiment of the invention.

FIG. 3 is a flowchart illustrating a method for acquiring new consumers having a payment token associated with a no preset spending limit account, in accordance with an embodiment of the invention.

FIG. 4 is a flowchart illustrating a method for processing an authorization request for a transaction with a payment token of a consumer, in accordance with an embodiment of the invention.

FIG. 5 is a block diagram of subsystems that may be present in computer apparatuses that are used in the system shown in FIG. 1, according to embodiments of the invention.

### DETAILED DESCRIPTION

Embodiments of the invention address the above-noted problems by providing a card or other payment token with a no preset spending limit (NPSL). Transactions are processed by assessing risk in real-time based on information from an open network. An open network (e.g., VisaNet) can allow many different issuers and acquirers to communicate with each other when payment transactions and other types of transactions are conducted. In embodiments of the invention, exposure limits can be evaluated in real-time with every transaction. By constantly evaluating exposure limits in real-time, issuers can make informed and accurate decisions regarding whether or to authorize payment transactions conducted using payment tokens associated with no present spending limits. This was not possible with closed networks, because of the limited financial data obtainable by such closed networks.

Note that an “exposure limit” differs from a “spending limit.” A “spending limit” is a limit on a purchase amount for a purchase conducted by a consumer. For example, a spending limit for a credit card may be set to a maximum of $5000 per transaction. The transaction may be declined if the consumer tries to make a purchase that exceeds $6000 even though the consumer may have sufficient credit to conduct the transaction and even though the risk of the consumer not re-paying the $6000 is low. On the other hand, an “exposure limit” (e.g., a credit limit) can be a limit that is used by an issuer or other entity and that is associated with how much secured and/or unsecured funds that the entity is willing to lend the consumer based on currently available information. If, for example, an issuer is willing to extend $6000 of credit to a consumer based on currently available information, then the exposure limit will be $6000.

In embodiments of the invention, once a consumer is approved for a card with an NPSL, a generous initial exposure limit is given to the consumer. Every time the consumer attempts to conduct a transaction using the card, the exposure limit is updated in real-time. If the consumer attempts to spend over the exposure limit, the consumer may be given an early warning (e.g., phone or electronic message) that the transaction may be declined and that the consumer can provide new information that may increase the exposure limit. Alternatively, if the consumer anticipates having to make a high dollar transaction that could place the consumer's account over the exposure limit, the consumer could provide new information suggesting good creditworthiness to the issuer before conducting the transaction. The new information could be used to increase the exposure limit before the transaction is conducted and avoid early warning messages. The risk of each transaction is assessed in real-time based on the updated exposure limit, the current transaction information, and possibly the information available over the open network.

Certain embodiments of the invention may provide one or more technical advantages to a number of entities. Such entities may include issuers, merchants, and consumers.

A technical advantage to an issuer is that providing cards (or other payment tokens) with NPSLs expands the penetration of cards into business spend categories and could capture transactions typically conducted using more traditional payment methods, e.g. checks.

A technical advantage to a consumer having a small business is that a card with an NPSL allows small businesses to purchase high dollar items such as raw material and rent, which are currently constrained by low pre-set spending limits associated with conventional cards. Another technical advantage to a consumer is that the exposure limit will not be dependent on the consumer's tenure. Since the consumer acquisition process can be stringent, initial exposure limits can be generous and can be based on the needs of the consumer. Another technical advantage to a consumer is that risk assessment is based on transactions on cards from more than one issuer. For example, unlike transactions conducted using a closed system, exposure limits can be calculated based on transactions from more than one issuer. In addition, another technical advantage to a consumer is that providing early warnings to the consumer could eliminate the possibility of a point-of-sale decline without prior notice. In yet another technical advantage to a consumer, the consumer can provide additional information to increase her exposure limit at the point-of-sale or in anticipation of a high dollar transaction. Thus, the consumer can potentially avoid point-of-sale declines and early warnings.

A technical advantage to a merchant is that providing cards with an NPSL to consumers results in increased revenue to the merchant.

Certain embodiments of the invention may include none, some, or all of the above technical advantages. One or more other technical advantages may be readily apparent to one skilled in the art from the figures, descriptions, and claims included herein.

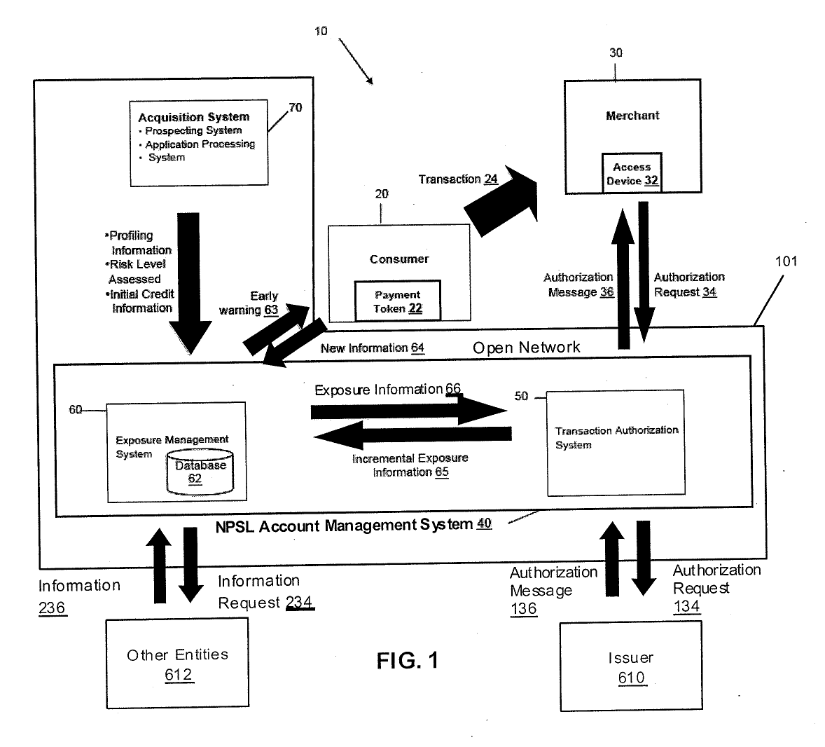

FIG. 1 illustrates a system 10 in accordance with an embodiment of the invention. The system 10 includes a consumer 20 having a payment token 22 for conducting a transaction 24 and a merchant 30 having an access device 32 for interacting with the payment token 22. The system 10 also includes an open network 101 (or open payment processing network) including an NPSL account management system 40 having a transaction authorization system 50 for authorizing transactions 24 and an exposure management system 60 for calculating real-time exposure information. The exposure management system 60 includes a database 62. In addition, the open network 101 includes an acquisition system 70 for prospecting for new consumers 20 and for processing applications from applicants. Although components 50, 60, and 70 are shown as being part of the open network 101, they may be outside of the open network 101 in other embodiments. In both cases, messages may be sent to or received from such components 50, 60, and 70 via the open network 101.

The consumer 20 is in operative communication with the merchant 30 to make transactions 24 with the merchant 30. The merchant 30 is also in operative communication with the transaction authorization system 50 to send authorization requests 34 to transaction authorization system 50 and to receive authorization messages 36 from transaction authorization system 50. (For ease of illustration, an acquirer associated with the merchant 30 is not shown.) The transaction authorization system 50 is also in operative communication with the exposure management system 60 to send incremental exposure information 65 to the exposure management system 60 and to receive exposure information 66 from the exposure management system 60. The exposure management system 60 is also in operative communication with the consumer 20 to send an early warning message 63 to the consumer 20 a prospective transaction 24 may be declined. In response, the consumer 20 may send new information back to the exposure management system 60 that could be used to increase the exposure limit and allow authorization of transaction 24. The exposure management system 60 is also in operative communication with the acquisition system 70 to receive information gathered during acquisition of new consumers 20.

The exposure management system 60 is also in communication with other entities 612. An information request 234 can be sent to the other entities 612 by the exposure management system 60 and information 236 can be provided by the other entities 612 to the exposure management system 60. Some examples of other entities 612 include other issuers, acquirers, as well as organizations such as credit agencies.

The consumer 20 refers to an entity or a group of entities that are capable of conducting transactions 24 with the merchant 30. In one embodiment, consumer 20 may be an individual and/or a commercial entity. In another embodiment, consumer 20 may be an organization such as a business. For example, consumer 20 may be a new business that is starting up and requires a high exposure limit to purchase high dollar items on credit. In some embodiments, consumer 20 may be a customer of issuer 610. For example, consumer 20 may be a small business that has a business account with issuer 20 (e.g., a bank).

The payment token 22 refers to any suitable device or voucher that allows the prospective transaction 24 to be conducted with the merchant 30 and that is associated with an NPSL account of consumer 20. The payment token 22 may be in any suitable form. Some examples of payment tokens include smart cards, magnetic stripe cards, keychain devices (such as the Speedpass™ commercially available from Exxon-Mobil Corp.), etc. Other examples of payment tokens include cellular phones, personal digital assistants (PDAs), pagers, payment cards such as credit cards, security cards, access cards, smart media, transponders, and the like. In yet another example, a payment token 22 can be an e-commerce number that allows payments and money transferred through the Internet to the merchant 30.

In one embodiment, a payment token 22 comprises a computer readable medium and a body. The computer readable medium may be on the body of the payment token 22. The body may in the form of a plastic substrate, a housing, or other structure. The computer readable medium may be a memory that stores data and may be in any suitable form. Exemplary computer readable media may be in any suitable form including a magnetic stripe, a memory chip, etc. If the payment token 22 is in the form of a card, it may have an embossed region ER which is embossed with a PAN (primary account number). The computer readable medium may electronically store the PAN as well as other data such as PIN data.

If desired, the issuer 610 of the payment token 22 may receive an authorization request 134 from the transaction authorization system 50, and may provide an authorization message 136 to the transaction authorization system 50, if the transaction authorization system does not authorize the transaction by itself. An issuer 61 refers to any suitable entity that may open and maintain the NPSL account for the consumer 20. Some examples of issuers include a bank, a business entity such as a retail store, or a governmental entity. In many cases, the issuer 610 may also issue the payment token 22 associated with the NPSL account to consumer 20.

The merchant 30 refers to any suitable entity or entities that conducts transaction(s) 24 with consumer 20. The merchant 30 can use any suitable method to conduct the transaction 24. For example, the merchant 30 may use an e-commerce business to allow the transaction 24 to be conducted by the merchant 30 through the Internet. Other examples of merchants 30 include department stores, gas stations, drug stores, grocery stores, or other suitable business.

The merchant 30 may also have, or may receive communications from, an access device 32 that can interact with the payment token 22. In the illustrated embodiment, the access device 32 is located at the merchant 30. However, the access device 32 may be located at any other suitable location in other embodiments of the disclosure.

The access device 32 may be in any suitable form. Some examples of access devices include point of sale (POS) devices, cellular phones, PDAs, personal computers (PCs), tablet PCs, handheld specialized readers, set-top boxes, electronic cash registers (ECRs), automated teller machines (ATMs), virtual cash registers (VCRs), kiosks, security systems, access systems, websites, and the like. The access device 32 may use any suitable contact or contactless mode of operation to send or receive data from payment tokens 22.

If access device 32 is a point of sale terminal, any suitable point of sale terminal may be used and may include a reader, a processor, and a computer readable medium. The reader may include any suitable contact or contactless mode of operation. For example, exemplary card readers can include radio frequency (RF) antennas, optical scanners, bar code reader, magnetic stripe readers, etc. to interact with the payment token 22.

An acquirer refers to any suitable entity that has an account with merchant 30. In some embodiments, the issuer 610 may also be the acquirer. For simplicity of illustration, acquirers are not shown, but they are in communication with the open network.

The NPSL account management system 40 manages NPSL accounts to prevent unchecked risk to issuers 610 of NPSL accounts. The NPSL account management system 40 comprises a transaction authorization system 50 and an exposure management system 60.

One or more of the components of the NPSL account management system 40, the acquisition system 70, the issuer 610, or other entities 612may have or operate a server computer and/or a database. The server computer may be coupled to the database and may include any hardware, software, other logic, or combination of the preceding for servicing the requests from one or more client computers. Server computer may use any of a variety of computing structures, arrangements, and compilations for servicing the requests from one or more client computers. In one embodiment, the server computer may be a powerful computer or cluster of computers. For example, the server computer can be a large mainframe, a minicomputer cluster, or a group of servers functioning as a unit. In one example, the server computer may be a database server coupled to a Web server. In this example, the server computer may service the requests of one or more client computers.

A server computer may include a computer readable medium (CRM) and a processor in communication with the CRM. The CRM comprises code executable by the processor. Any component of system 10 may have a server computer having code with instructions for performing functions of the component. For example, the issuer 610 may have a server computer with a CRM including code for receiving authorization requests, code for sending authorization messages, and code for determining whether to authorize/decline transactions. In another example, the NPSL account management system 40 may have a server computer with a CRM including code for communicating authorization messages and authorization requests, code for determining exposure limits, code for processing transactions, codes for assessing the risk associated with a transaction, code for assessing the profitability, code for comparing the risk to the exposure limit, code for sending messages to the consumer 20, and code for receiving information from the acquisition system 70. As another example, the acquisition system 70 may include a server computer with a CRM including code for processing applications and code for communicating information to the NPSL account management system 40.

The open network 101 refers to a network of suitable entities that have information related to transactions 24 and credit information associated with consumer 20. The open network 101 may communicate with more than one issuer of payment tokens 22. The open network 101 may also communicate with additional entities 612 associated with consumer 20 such as other banks, credit agencies, credit bureaus, and credit card agencies. In some embodiments, the entities on the open network 101 may share access to information regarding consumers 20. The open network 101 may include or be in operative communication with exposure management system 60, transaction authorization system 50, and acquisition system 70.

The open network 101 may include data processing subsystems, networks, and operations used to support and deliver authorization services, exception file services, and clearing and settlement services. An exemplary open network may include VisaNet™. Open networks that include VisaNet™ are able to process credit card transactions, debit card transactions, and other types of commercial transactions. VisaNet™, in particular, includes a VIP system (Visa Integrated Payments system) which processes authorization requests 34 and a Base II system which performs clearing and settlement services. The open network 101 may use any suitable wired or wireless network, including the Internet.

Transaction authorization system 50 assesses in real-time the risk associated with prospective transactions 24 and if the risk is acceptable, authorizes the prospective transaction 24 on behalf of the issuer. In some cases, the transaction authorization system 50 assesses the risk of prospective transactions 24 based on any suitable information. Such information may include exposure limits, real time exposure limits, and other suitable data for assessing risk that is provided by exposure management system 60. Some risk management processes and systems are described in U.S. patent application Ser. No. 10/863,813, filed on Jun. 7, 2004, which is herein incorporated by reference in its entirety for all purposes. The transaction authorization system 50 may also assess the risk of prospective transactions 24 based on information available on the open network such as transaction information. Based on the assessed risk, the transaction authorization system 50 determines whether to authorize or decline the prospective transaction 24 on behalf of the issuer. In some embodiments, the transaction authorization system 50 may obtain approval from an issuer to send the authorization message 36 to the merchant 30.

The authorization request 34 refers to any suitable information that may be used to determine whether to authorize or decline prospective transaction 24 on behalf of the issuer. The authorization request 34 may include information related to the prospective transaction 24 such as account number, amount of transaction 24, type of transaction 24, price per good or service to be purchased, stock keeping unit (SKU) numbers, location of transaction 24, form of the payment token 22, frequency of transaction 24, and other information captured at the point of sale. The authorization request 34 may also include other information such as merchant name, merchant category, location of the merchant, IP address, and email address. The authorization request 34 may also include authentication information related to the payment token 22 and consumer 20. For example, the authorization request 34 may include verification from merchant 30 that consumer 20 has provided a valid picture identification card to merchant 30 at the time of transaction 24.

The authorization message 36 refers to any suitable information used to authorize or decline transaction 24 conducted by consumer 20 on behalf of the issuer. For example, the authorization message 36 includes an indicator showing that the transaction was authorized or declined. The authorization message 36 may also include information indicating that the issuer of payment token 22 approved the authorization message. In cases where consumer's exposure is approaching or is above the real-time exposure limit, the authorization message 36 may include an early warning message. In one embodiment, the authorization message 36 may include a request for consumer 20 to communicate with exposure management system 60 to provide new information to reassess the real-time exposure limit. In another embodiment, the authorization message 36 may include new terms for using the payment token 22 to complete the transaction 24.

The exposure management system 60 assesses the credit exposure of consumers 20, sets real-time exposure limits, and gathers new information 64 from consumers 20 and other sources for reassessing exposure limits. In the illustrated embodiment, the exposure management system 60 includes a database 62.

An exposure limit can refer to an authorization limit associated with the payment token 22. In some cases, the exposure limit is related to the maximum amount of secured and unsecured funds that the issuer is willing to lend such that, on the margin, the issuer makes a break-even decision.

Real-time exposure limits can be updated when triggered by occurrences that could affect the real-time exposure limit. For example, the exposure management system 60 may be triggered to update the real-time exposure limit every time a transaction 24 is requested. In another example, the exposure management system 60 may update the real-time exposure limit as it receives incremental exposure information 65 from the transaction authorization system 50 such as an indication that transaction 24 was declined. In yet another example, the exposure management system 60 may update the real-time exposure limit as it receives or is otherwise made aware of new information 64 from the consumer 20 or from the open network 101. In one case, the exposure management system 60 may update a real-time exposure limit when a credit bureau publishes new credit reports. Real-time exposure limits can be updated on a periodic basis (e.g., daily or hourly) as well.

The incremental exposure information 65 can refer to any suitable information related to each transaction 24 that the exposure management system 60 can use to update the exposure limit. The exposure information 66 can refer to any suitable information related to credit exposure to a consumer such as credit exposure and real-time exposure limits.

The database 62 may include any hardware, software, firmware, or combination of the preceding for storing and facilitating retrieval of information. Also, the database 62 may use any of a variety of data structures, arrangements, and compilations to store and facilitate retrieval of information. In the illustrated embodiment, the database 62 is located in the exposure management system 60. The database 62 may be located on other components of system 10 in other embodiments. For example, the database 62 may be located on the payment token 62. In another example, the database 62 may be located on a server available over the open network 101.

Information stored on the database 62 may include any suitable information related to acquiring consumers, managing credit, processing transactions 24, managing NPSL accounts, determining exposure levels, and setting exposure limits. For example, information stored on the database 62 could include information related to prospective transactions 24, exposure information 66 associated with the prospective transactions 24, profile information related to consumers 20, risk level assessments, authorization/declination of transactions 24, and other suitable information related to the processes in system 10.

The acquisition system 70 acquirers new consumers 20 by prospecting for prospective applicants and processing their applications. In the illustrated embodiment, the acquisition system 70 identifies applicants that are highly-qualified for an NPSL account based on information available over the open network. In one case, the acquisition system 70 may pre-qualify a prospective applicant for an NPSL account. In another case, the acquisition system 70 may solicit applications from the highly-qualified prospective applicants.

In the illustrated embodiment, the acquisition system 70 receives and accepts applications from solicited and unsolicited applicants. In another embodiment, transaction authorization system may only accept applications from pre-qualified prospective applicants. Once an application is received, the acquisition system 70 assesses the profile in the application to determine the profitability of having NPSL accounts with the applicant. The acquisition system 70 approves or declines the NPSL account, on behalf of the issuer, based on the profitability assessment. Once the NPSL account is approved, the applicant is converted into consumer 20 with an NPSL account. The acquisition system 70 or exposure management system 60 then sets an initial exposure limit for the NPSL account. In an embodiment where consumer 20 is determined to be highly-qualified, acquisition system 70 or exposure management system 60 may give consumer 20 a generous initial exposure limit. In one embodiment, the issuer 610 may then issue payment token 22 associated with the NPSL account.

The acquisition system 70 sends profile information such as application information gathered during the acquisition of new consumer 20 to exposure management system 60. The acquisition system 70 also sends the initial exposure limit associated with new consumer 20 to the exposure management system 60 along with any risk assessment information. In another embodiment, the exposure management system 60 may determine the initial exposure limit.

The consumer 20 then purchases a good or service at the merchant 30 using the payment token 22 such as a card having an NPSL account. The consumer's payment token 22 interacts with an access device 32 such as a POS (point of sale) terminal at the merchant 30. For example, the consumer 20 may take the payment token 22 and swipe it through an appropriate slot of a cardreader in the POS terminal. Alternatively, the POS terminal may have a contactless reader, and the payment token 22 may be a contactless device such as a contactless card.

The authorization request 34 is then forwarded to the transaction authorization system 50. After receiving the authorization request 34, incremental exposure information 65 is sent to the exposure management system 60. The exposure management system 60 updates in the real-time exposure limit and the exposure based on the incremental exposure information 65. The exposure management system 60 forwards the exposure information 66 including the updated real-time exposure limit and the updated exposure to transaction authorization system 50. The transaction authorization system 50 assesses the risk of the prospective transaction 24 using the exposure information. In some embodiments, based on the risk assessed, the transaction authorization system 50 decides, on behalf of the issuer, whether the transaction 24 should be authorized or declined. The transaction authorization system 50 sends authorization message 36 to merchant 30 indicating that the transaction is authorized (or is declined). In other embodiments, the transaction authorization system 50 may send an authorization request 134 to an issuer 610 and may receive an authorization message 136 from the issuer 610, if the issuer 610 wants to make an additional authorization determination.

Before the transaction authorization system 50 declines any transaction, the exposure management system 60 sends an early warning message 63 to consumer 20 that transaction 24 may be declined. The consumer 20 has the option of providing new information 64 to exposure management system 60 to increase the exposure limit to allow transaction 24 to be authorized.

After the merchant 30 receives authorization message 36, the access device 32 at the merchant 30 may then provide an authorization message 36 to the consumer 20. The authorization message 36 may be displayed by the access device 32, or may be printed out on a receipt.

At the end of the day, a normal clearing and settlement process can be conducted on the open network. A clearing process is a process of exchanging financial details between merchant and an issuer to facilitate posting to a consumer's NPSL account and reconciliation of the consumer's settlement position. Clearing and settlement can occur simultaneously.

Modifications, additions, or omissions may be made to the system 10 without departing from the scope of the disclosure. The components of the system 10 may be integrated or separated according to particular needs. Moreover, the operations of the system 10 may be performed by more, fewer, or other system modules. Additionally, operations of the system 10 may be performed using any suitable logic comprising software, hardware, other logic, or any suitable combination of the preceding.

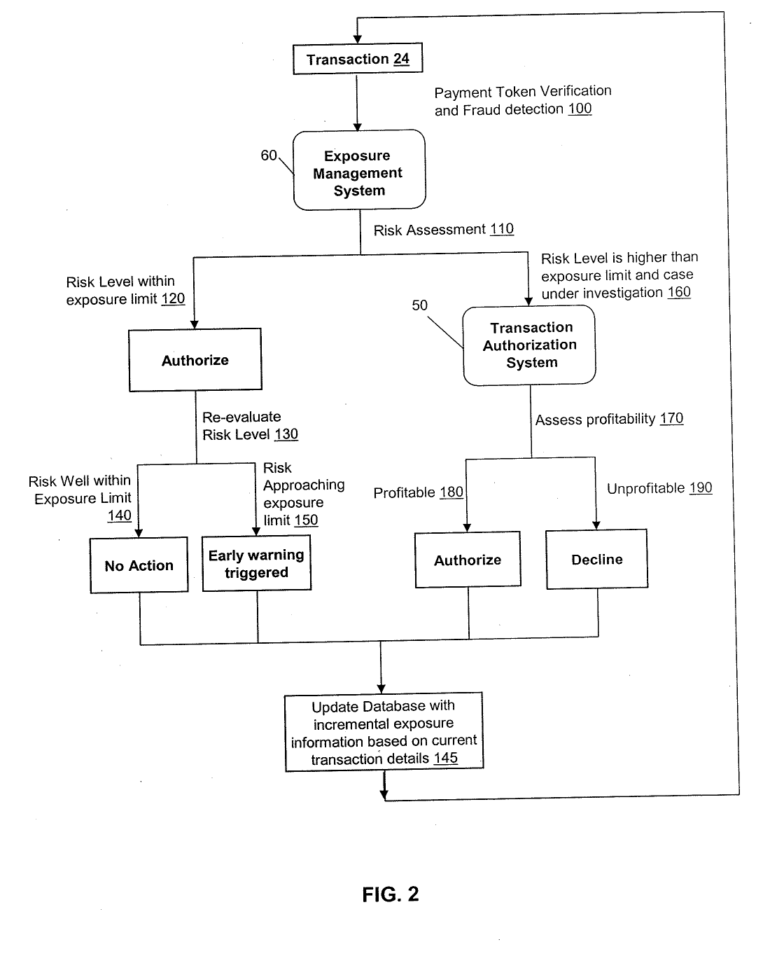

FIG. 2 is a block diagram illustrating the decision making process made through the NPSL account management system 40, in accordance with an embodiment of the invention. As shown, the decision making process begins with exposure management system 60 being notified of prospective transaction 24 conducted by the consumer 20 using payment token 22 (step 100). The exposure management system 60 is given payment token verification information and fraud detection information. In some embodiments, this information may indicate whether payment token 22 is authenticated, the consumer 20 is authenticated, the transaction 24 is not fraudulent, or some combination thereof. In other embodiments, the exposure management system 60 may authenticate consumer 20 and the payment token 22 using the payment token verification information and may verify that transaction 24 is not fraudulent based on the fraud detection information. In one example, the exposure management system 60 may communicate the payment verification information to the issuer so that the issuer can authenticate the payment token 22 and the consumer 20 for exposure management system 60.

The exposure management system 60 assesses the risk or exposure level of the consumer 20 based on the prospective transaction 24 and determines whether the exposure level is within the current exposure limit of consumer's NPSL account (step 110). In some cases, the exposure management system 60 may also update the current exposure limit based on the prospective transaction 24.

If the assessed risk or exposure level is within the current exposure limit of consumer's NPSL account, the transaction authorization system 50 will authorize the transaction 24, on behalf of the issuer (step 120). The exposure management system 60 then re-evaluates the risk or exposure level (step 130). In some embodiments, the transaction authorization system 50 may send an authorization message 36 to the merchant 30 authorizing the transaction 24 on behalf of the issuer. In other embodiments, the issuer or acquirer may send an authorization message 36 to the merchant 30.

If the re-evaluated risk or exposure level is well within the exposure limit, no action is taken (step 140). The exposure management system 60 then updates information on the database 62 using the incremental exposure information 65 based on the details of the transaction 24 (step 145).

If the re-evaluated risk or exposure level is approaching the exposure limit, an early warning 63 is triggered. In one embodiment, the exposure management system 60 sends an early warning message 63 to the consumer 20 to notify the consumer 20 that the risk or exposure level is approaching the exposure limit associated with the NPSL account. The consumer 20 may have the option of providing new information 64 that allows the exposure management system 60 to increase the exposure limit. In some cases, the early warning message 63 may not convey that the amount of the exposure limit or a discussion that the consumer 20 is approaching the exposure limit. For example, the consumer 20 may be notified that a recent transaction is higher than a typical transaction made by consumer 20 according to the spending history of consumer 20. In response, the consumer 20 may provide additional information to explain the reason for the high amount of the transaction.

The exposure management system 60 updates the information on the database 62 using the incremental exposure information 65 based on the details of the transaction 24 (step 145).

If, however, the risk or exposure level is higher than the exposure limit, then the case is placed under investigation (step 160). The transaction authorization system 50 assesses the profitability of authorizing the transaction 24 for the issuer (step 170). The profitability of the transaction 24 can be based on additional findings such as an assessment of additional information provided by the consumer 20 or another entity.

If the transaction authorization system 50 decides that authorizing transaction 24 will probably be profitable for the issuer, the transaction authorization system 50 will authorize the transaction 24 (step 180). The exposure management system 60 then updates information on the database 62 using the incremental exposure information based on details of transaction 24 (step 145).

If the transaction authorization system 50 decides that the authorizing transaction 24 will probably be unprofitable for the issuer, then the transaction authorization system 50 will decline the transaction (step 190). After the decision is made, the exposure management system 60 updates the information on the database 62 using the incremental exposure information 65 based on details of the transaction 24 (step 145).

Modifications, additions, or omissions may be made to the process without departing from the scope of the disclosure. The process may include more, fewer, or other steps. Additionally, steps may be performed in any suitable order without departing from the scope of the disclosure.

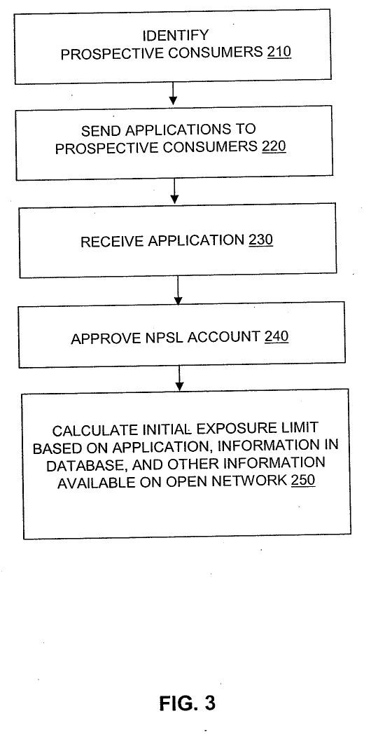

FIG. 3 is a flowchart illustrating a method for acquiring new consumers having a payment token 22 associated with an NPSL account, in accordance with an embodiment of the invention. The acquisition system 70 first identifies prospective consumers 20 (step 210). In some embodiments, the acquisition system 70 retrieves information available over the open network to identify and target prospective consumer 20 that may be highly profitable to the issuer. For example, the acquisition system 70 may identify prospective consumers 20 by their expected net present value (NPV) determined from information available over the open network.

The acquisition system 70 then solicits applications from the identified prospective consumers (step 220). The acquisition system 70 receives applications from applicants (step 230). In some embodiments, the acquisition system 70 only receives applicants that have been solicited by acquisition system 70. In these cases, the acquisition system 70 may only select applications from those applicants that have been prescreened as potentially profitable to the issuer. In other embodiments, the acquisition system 70 may receive applications from unsolicited applicants or a combination of solicited and unsolicited applicants.

After receiving the applications, the acquisition system 70 reassesses the risk associated with opening an NPSL account for each applicant. Based on the risk assessed, the acquisition system 70 approves or does not approve the NPSL account. In the illustrated embodiment, the acquisition system 70 approves the NPSL account on behalf of the issuer (step 240). In some embodiments, the acquisition system 70 opens the NPSL account for consumer 20 on behalf of the issuer. In other embodiments, the issuer will open the NPSL account.

The acquisition system 70 will then calculate an initial exposure limit for the new NPSL account based on the application, information stored in the database 62, and any other suitable information available on the open network (step 250). In some embodiments, the issuer now issues to consumer 20 a payment token 22 associated with the account having a NPSL. In other embodiments, the acquisition system 70 may issues the payment token 22 on behalf of the issuer.

Modifications, additions, or omissions may be made to the method without departing from the scope of the disclosure. The method may include more, fewer, or other steps. Additionally, steps may be performed in any suitable order without departing from the scope of the disclosure.

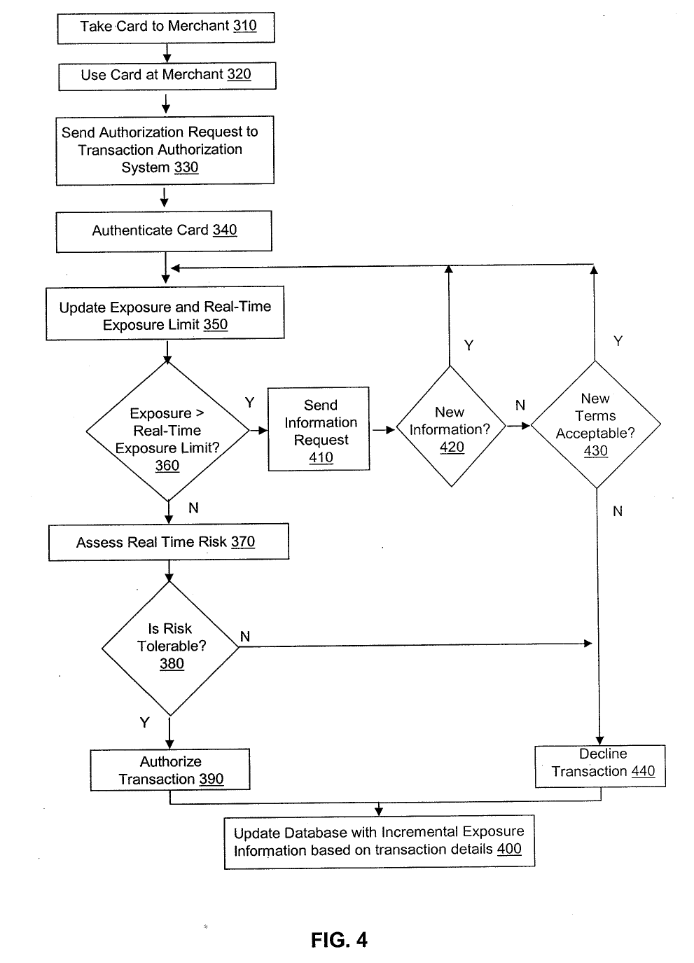

FIG. 4 is a flowchart illustrating a method for processing an authorization request to make a transaction 24 using a payment token 22 of a consumer 20 with a merchant 30, in accordance with an embodiment of the invention.

In the illustrated embodiment, the consumer 20 had been issued a card or other payment token 22 associated with an NPSL account. The consumer 20 takes the card to the merchant 30 to make a transaction 24 such as making a purchase or buying a service (step 310).

The merchant 30 swipes the card through a cardreader or other access device 32 (step 320). In response, the access device 32 sends an authorization request 34 to the transaction authorization system 50 (step 330). The authorization request 34 may contain card authentication information and information related to the prospective transaction 24. In other embodiments, other entities such as the acquirer associated with merchant 30 or the consumer 20 may provide authentication information and/or transaction information to the transaction authorization system 50.

In the illustrated embodiment, the transaction authorization system 50 authenticates the card on behalf of the issuer using the card authentication information in the authorization request 34 (step 340). For example, the issuer may provide authentication information to the transaction authorization system 50 to compare to the authentication information in the authorization request 34. If the information is comparable, the transaction authorization system 50 may authenticate the card on behalf of the issuer. In another embodiment, the transaction authorization system 50 may forward the authentication information in an authorization request 34 to the issuer 610. In response, the issuer 610 may authenticate the card and notify the transaction authorization system 50 that the card is authentic. In some embodiments, authenticating the card may include authenticating the consumer 20 and/or verifying that the transaction 24 is not fraudulent.

After the transaction authorization system 50 authenticates the card, the exposure management system 60 retrieves the previous exposure and real-time exposure limit associated with the NPSL account of the consumer 20 stored on the database 62. The exposure management system 60 updates the exposure level and real-time exposure limit with information related to the transaction 24 and compares the updated exposure level to the updated real-time exposure limit.

If the updated exposure level is below the real-time exposure limit (step 360), the transaction authorization system 50 assesses the real time risk of the prospective transaction (step 370). In the illustrated embodiment, the transaction authorization system 50 assesses the risk of the prospective transaction based on the exposure information 66 from the exposure management system 60, from the transaction information in the authorization request 34 from the merchant 30, and from any other suitable information available over the open network 101. In another embodiment, if the updated exposure level is below the real-time limit (step 360), the transaction authorization system 50 may not assess the risk of the prospective transaction 24 and may send an authorization message to the merchant 30 authorizing the transaction 24 without risk assessment (step 390). In yet another embodiment, if the updated exposure level is below the real-time limit (step 360), the transaction authorization system 50 may perform a cursory risk assessment and send the authorization message 36 to the merchant 30 authorizing the transaction 24 (step 390).

If the risk of the prospective transaction is tolerable (step 380), the transaction authorization system 50 sends an authorization message 36 to the merchant 30 authorizing the transaction 24 on behalf of the issuer 610. If the risk is not tolerable (step 380), the transaction authorization system 50 sends an authorization message to the merchant 30 declining the transaction on behalf of the issuer. In either case, the information from the risk assessment and exposure information is used to update information stored in the database 62 (step 400).

In one embodiment, the exposure management system 60 may also compare the updated exposure level to the real-time exposure limit to determine whether the exposure level is approaching the real-time limit. If it determined that the exposure level is approaching the real-time exposure limit, the exposure management system 60 sends an early warning message to the consumer 20 and then the transaction authorization system 50 authorizes the transaction 24 on behalf of the issuer 610 (step 390). In one case, the exposure management system 60 determines that the exposure level is reaching the exposure limit if the exposure level is determined to be within a certain predefined amount or predefined percentage of the exposure limit. In one example, a real-time exposure limit is $1000, a current exposure level is $950, and a predefined percentage is 10%. Since the current exposure level $950 is within 10% ($100) of the real-time exposure limit of $1000, the exposure management system 60 determines that the exposure level is approaching the real-time exposure limit and sends an early warning message to the consumer 20.

If the updated exposure is above the real-time limit (step 360), the exposure management system 60 sends an information request to the consumer (step 410). In other cases, the consumer may volunteer new information. If the consumer 20 provides new information (step 420), the exposure management system 60 will update the real-time exposure limit based on the new information (step 350).

If the consumer 20 does not provide new information (step 420), the exposure management system 60 may provide, on behalf of the issuer, new terms for using the card. In some cases, the new terms may apply only to the prospective transaction 24. If the terms are acceptable to (approved by) the consumer 20 (step 430), the exposure management system 60 may update the real-time exposure limit based on the new terms (step 350). In another embodiment, if the consumer 20 does not provide new information, the transaction authorization system 50 will send an authorization message to the merchant declining the transaction (step 440) without providing new terms to the consumer 20.

In the illustrated embodiment, if the new terms are not acceptable to the consumer 20 (step 430), the transaction authorization system 50 sends an authorization message 36 to the merchant 30 declining the transaction 24 on behalf of the issuer. The exposure management system 60 updates the information stored in the database 62 using exposure information 66 and any other information resulting from the processing of the authorization request 34.

In another embodiment, the exposure management system 60 may also update the real-time exposure limit based on the new information 64. New information may be provided by the consumer 20 in response to the information request from the exposure management system 60. The consumer 20 may also provide information that is not associated with the information request. New information may also be provided by other entities over the open network 101.

In one embodiment, the exposure management system 60 may also compare the updated exposures levels to real-time exposure limits on a daily basis. If an updated exposure level is approaching the updated real-time exposure limit, the exposure management system 60 may send an early warning message to the consumer 20 that the exposure is reaching the exposure limit. In some cases, the exposure management system 60 may request new information to increase the exposure limit to ensure that future transactions will not be declined.

In one embodiment, the exposure management system 60 may provide an early warning message 63 before any prospective transaction 24 is declined. In one embodiment, when the transaction 24 places the exposure level well above the exposure limit, the exposure management system 60 may contact the consumer 20 to provide an early warning 63 at the point of sale before transaction 24 is declined. In some cases, the exposure management system 60 may ask a series of questions or request new information 64 regarding the transaction 24, the consumer, the consumer's job, the consumer's business, or other suitable information. For example, the exposure management system 60 may ask the consumer 20 a series of questions such as “Do you still have a job?” or “How is your business?” or “Is your business solvent?” In another example, exposure management system 60 may request the information such as a current bank statement to show that the consumer 20 has funds to pay for transaction 24. In another embodiment, the exposure management system 60 or an agent of the exposure management system 60 may contact the consumer 20 to get new information 64 from the consumer 20 when the transaction 24 is flagged as potentially fraudulent. For example, if the consumer 20 is trying to buy a car using a payment token 22 associated with a business account, the exposure management system 60 may contact the consumer 20 to verify that the transaction 24 is a legitimate business expense.

In one embodiment, the consumer 20 may contact the exposure management system 60 before conducting the transaction 24 to provide new information 64 to exposure management system 60 for reassessing the exposure limit. In some cases, the exposure management system 60 may use this new information 64 to increase the exposure limit before the transaction 24. In this way, the consumer 20 may avoid any inconveniences associated with conducting transactions 24 well over the exposure limit such as phone calls from the issuer or a declination at the point of sale. In one example, the consumer 20 may be a small business owner that will be on a business trip to Italy for two months, expects to make high dollar transactions 24 on the business trip, and cannot be reached over the phone during the business trip. In this example, the consumer 20 may contact the exposure management system 60 to arrange advanced approval for high dollar transactions 24 using the payment token 22. In this case, the exposure management system 60 stores this new information 64 in the database 62 and increases the exposure limit accordingly.

Modifications, additions, or omissions may be made to the method without departing from the scope of the disclosure. The method may include more, fewer, or other steps. Additionally, steps may be performed in any suitable order without departing from the scope of the disclosure.

Embodiments of the invention have a number of advantages. For example, in embodiments of the invention, a real time risk analysis can be used by an issuer or other entity to determine the risk associated with providing credit to a consumer. An accurate real time risk analysis is made possible because, among other reasons, the above-described open network consolidates information about a particular consumer. The issuer can therefore comfortably provide a “no preset spending limit” to a consumer's payment token, since the issuer can make real time determinations as to whether or not it is risky to loan the consumer high amounts of money. This is not possible with a closed system. Other advantages are described above.

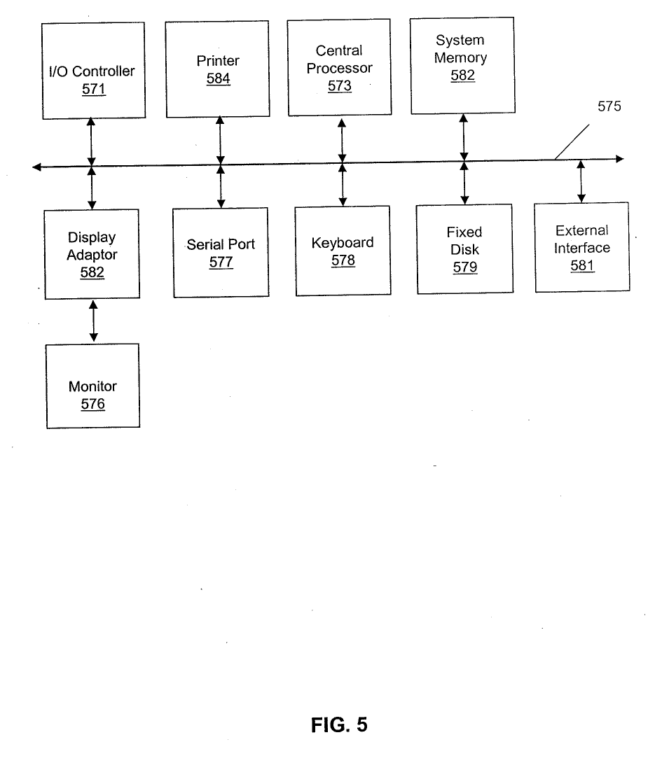

FIG. 5 is a block diagram of subsystems that may be present in computer apparatuses that are used in the system 10 shown in FIG. 1, according to embodiments of the invention.

The various participants and elements in the previously described Figures may operate using one or more of the computer apparatuses to facilitate the functions described herein. Any of the elements in the Figures may use any suitable number of subsystems to facilitate the functions described herein. Examples of such subsystems or components are shown in a FIG. 5.

The subsystems shown in FIG. 5 are interconnected via a system bus 575. Additional subsystems such as a printer 584, keyboard 578, fixed disk 579 (or other memory comprising computer readable media), monitor 576, which is coupled to display adapter 582, and others are shown. Peripherals and input/output (I/O) devices, which couple to the I/O controller 571, can be connected to the computer system by any number of means known in the art, such as a serial port 577. For example, the serial port 577 or the external interface 581 can be used to connect the computer apparatus to a wide area network such as the Internet, a mouse input device, or a scanner. The interconnection via system bus allows the central processor 573 to communicate with each subsystem and to control the execution of instructions from system memory 582 or the fixed disk 579, as well as the exchange of information between subsystems. The system memory 582 and/or the fixed disk 579 may embody a computer readable medium. Any of these elements may be present in the previously described features. For example, the previously described “server computer” may have one or more of these components shown in FIG. 5.

It should be understood that the present disclosure as described above can be implemented in the form of control logic using computer software in a modular or integrated manner. Based on the disclosure and teachings provided herein, a person of ordinary skill in the art will know and appreciate other ways and/or methods to implement the present disclosure using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

A recitation of “a”, “an” or “the” is intended to mean “one or more” unless specifically indicated to the contrary.

The above description is illustrative and is not restrictive. Many variations of the disclosure will become apparent to those skilled in the art upon review of the disclosure. The scope of the disclosure should, therefore, be determined not with reference to the above description, but instead should be determined with reference to the pending claims along with their full scope or equivalents.

One or more features from any embodiment may be combined with one or more features of any other embodiment without departing from the scope of the disclosure.

1. A method comprising:
receiving, by a server computer, an authorization request for a transaction conducted with a payment token from a merchant via an open payment processing network, the payment token associated with an account having a no preset spending limit;
determining, by the server computer, an exposure limit of the account in real-time based on information obtained by the open payment processing network; and
determining, by the server computer, whether or not to authorize the transaction based on the determined exposure limit.

2. The method of claim 1 further comprising updating, by the server computer, an exposure level based on the information obtained by the open payment processing network.

3. The method of claim 2 further comprising sending an early warning message to the consumer if the updated exposure level is determined to be approaching the determined exposure limit.

4. The method of claim 2 wherein determining, by the server computer, whether or not to authorize the transaction based on the determined exposure limit comprises comparing the updated exposure level to the exposure limit determined in real-time.

5. The method of claim 4 further comprising sending authorization in an authorization message to the merchant if the updated exposure level is below the determined exposure limit.

6. The method of claim 4 further comprising sending an authorization request to an issuer for an additional authorization determination if the updated exposure level is below the determined exposure limit.

7. The method of claim 1 further comprising storing the determined exposure limit in a database for subsequent exposure limit determinations.

8. The method of claim 1 further comprising:
sending new terms associated with the account to the consumer;
receiving approval of the new terms from the consumer; and
updating the exposure limit based on the new terms.

9. The method of claim 1 further comprising:
sending a request for new information to the consumer;
receiving the new information from the consumer in response to the request; and
updating the exposure limit based on the new information.

10. The method of claim 1 wherein the payment token is a phone.

11. A system comprising:
a processor; and
a computer readable medium coupled to the processor and comprising code executable by the processor, the computer readable medium comprising:
code for receiving an authorization request for a transaction conducted with a payment token from a merchant via an open payment processing network, the payment token associated with an account having a no preset spending limit;
code for determining an exposure limit of the account in real-time based on information obtained by the open payment processing network; and
code for determining whether or not to authorize the transaction based on the determined exposure limit.

12. The system of claim 11 wherein the computer readable medium further comprises code for updating an exposure level based on the information obtained by the open payment processing network.

13. The system of claim 12 wherein the computer readable medium further comprises code for sending an early warning message to the consumer if the updated exposure level is determined to be approaching the determined exposure limit.

14. The system of claim 12 wherein the code for determining whether or not to authorize the transaction based on the determined exposure limit comprises code for comparing the updated exposure level to the exposure limit determined in real-time.

15. The system of claim 14 wherein the computer readable medium further comprises code for sending authorization in an authorization message to the merchant if the updated exposure level is below the determined exposure limit.

16. The system of claim 14 wherein the computer readable medium further comprises code for sending an authorization request to an issuer for an additional authorization determination if the updated exposure level is below the determined exposure limit.

17. The system of claim 11 wherein the computer readable medium further comprises code for storing the determined exposure limit in a database for subsequent exposure limit determinations.

18. The system of claim 11 wherein the computer readable medium further comprises:
code for sending new terms associated with the account to the consumer;
code for receiving approval of the new terms from the consumer; and
code for updating the exposure limit based on the new terms.

19. The system of claim 11 wherein the computer readable medium further comprises:
code for sending a request for new information to the consumer;
code for receiving the new information from the consumer in response to the request; and
code for updating the exposure limit based on the new information.

20. The system of claim 11 wherein the payment token is a phone.
